(19) United States
(12) Patent Application Publication
(10) Pub. No.: US 2011/0011054 A1
(43) Pub. Date: Jan. 20, 2011

(54) COMBUSTOR CASING

(76) Inventors: Ghenadie Bulat, Notts (GB); Peter Senior, Levittown, PA (US)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 12/933,723

(22) PCT Filed: Feb. 25, 2009
(86) PCT No.: PCT/EP2009/052199

§ 371 Date: Sep. 21, 2010

(30) Foreign Application Priority Data
Mar. 31, 2008 (EP) 08006508.9

(51) Int. Cl. F02C 7/00; F23R 3/22

(52) U.S. Cl. 60/39.091; 60/752; 415/47

(57) ABSTRACT

A combustor casing with an inner casing and an outer casing and a bimetallic element arranged on an inner side of the inner casing is provided. The inner casing includes a pre-chamber area, where combustion is initiated in a fuel rich state, with an upper end and a lower end, the upper end sized and configured to be connected to a burner head. The bimetallic element is located within the pre-chamber area.

### CROSS REFERENCE TO RELATED APPLICATIONS

This application is the US National Stage of International Application No. PCT/EP2009/052199 filed Feb. 25, 2009, and claims the benefit thereof. The International Application claims the benefits of European Patent Application No. 08006508.9 EP filed Mar. 31, 2008. All of the applications are incorporated by reference herein in their entirety.

### FIELD OF THE INVENTION

The present invention relates to a combustor casing, in particular of a gas turbine combustor, with reduced deposit formation and reduced hot spots for increased lifetime of a gas turbine engine and for the further diminishment of air pollution such as nitrogen oxides (NOx).

### BACKGROUND OF THE INVENTION

It is well-known that the use of non-standard liquid fuels and/or mis-manufactured fuel nozzles in low-emission burners in gas turbine engines can lead to deposits or even hot spots which later burn distorting or even eroding parts of the burner duct.

The mitigation of this mal-operation issue can be achieved by providing cooling air to the reverse side of the positions known from experience to be sensitive. Alternatively, holes can be provided to spill film cooling air over the hot surface at such points. Either way, the air used is not available for pre-mixing with the fuel, thus increasing the NOx emissions in most types of modern gas turbine engines and other combustion equipment.

Other, dynamic approaches adjust cooling during operation relying on (failure-prone) sensors and valves with contact surfaces between parts in relative motion (subject to wear).

SU 726428 describes a device for controlling the flow as a function of the temperature of the flowing medium.

U.S. Pat. No. 2,763,433 describes L-shaped plates redirecting exhaust gas by closing and opening of an orifice as a function of the exhaust gas temperature flowing through a conduit.

U.S. Pat. No. 2,673,687 describes a so-called “duck bill” type valve for controlling and directing the flow of hot exhaust gases as a function of the temperature of the exhaust gases.

U.S. Pat. No. 4,245,778 describes a vent control arrangement for energy conservation having bimetallic damper elements mounted in a draft hood, the bimetallic damper elements having alternate bimetal reeds of different initial tension, or alternate orientations, or different flexibility.

U.S. Pat. No. 4,441,653 describes a then tally actuated damper for a furnace exhaust gas flue.

U.S. 6,039,262 describes a bimetallic actuator for heat transfer applications between a hot stream and a coolant stream.

In a former application the applicant describes a cooling channel of a combustor casing formed by an inner casing and an outer casing, where bimetallic elements are arranged in the cooling channel on either the inner casing or the outer casing for adjusting a coolant flow distribution as to avoid the formation of hot spots on the inner casing with a minimum amount of coolant.

### SUMMARY OF THE INVENTION

An object of the invention is therefore to provide a new combustor casing for reduced deposit formation and reduced hot spots for increased lifetime and reduced downtime of a gas turbine engine and for the further diminishment of air pollution such as nitrogen oxides. It is a further objective of the present invention to provide an advantageous gas turbine engine.

The objects are achieved by a combustor casing and a gas turbine engine as claimed in the independent claims. The depending claims define further developments of the invention.

An inventive combustor casing comprises an inner casing and an outer casing and a bimetallic element arranged on an inner side of the inner casing.

The invention exploits the different expansion coefficients of the materials from which the bimetallic elements are formed so that heating causes them to differentially bend depending on their arrangement.

According to the invention the inner casing comprises a pre-chamber area, where combustion is initiated in a fuel rich state, with an upper end and a lower end, the upper end sized and configured to be connected to a burner head. Additionally, the bimetallic element is located within the pre-chamber area.

In a first advantageous embodiment of the invention the bimetallic element—arranged within a pre-chamber area—is sized and configured to crack away deposits like carbon-build-up on a hot gas side of the inner casing of the pre-chamber. If not cracked-away carbon build-up subsequently would start to burn and distort or erode this hot part of the burner.

In another preferable arrangement the inner casing has a lip formed as a bimetallic part moving away from an over hot flame. The lip forms a kind of an anchor for the flame. The part of the flow which is inside the pre-chamber is squeezed to a small diameter whereas the part in the combustion chamber can expand to the full space available. Due to the velocity change, the flame may approach the surface high local heat transfer, which is reduced by the inventive movable parts.

In one advantageous arrangement the bimetallic lip simply bends radially outwardly relative to a longitudinal axis of the inner casing and away from a heat source. In another advantageous arrangement a recess is arranged in the wall of the inner casing and located in a wall area of the pre-chamber area, the recess sized and configured to allow the bimetallic lip to bend in the direction of an upper end of the pre-chamber in reaction to the occurrence of a hot spot so that the length of the pre-chamber is reduced, again moving the part away from the flame.

These bimetallic lip arrangements have the advantages of preventing hot spots without using air and of detaching the carbon as well, since the change in geometry will crack deposits.

Further advantages are that bimetallic elements react differentially to heat transfer from hot-spots. The self-adjustment reduces the hot-spot temperature and raises the temperature of the rest of the hot casing until the two temperatures approach each other.

Using such adjustment can reduce the cooling air which would typically have had to be provided “just in case” the part became a hot spot. Thus the total cooling air in a gas turbine can be reduced with an increase in thermal efficiency of the cycle for the same maximum hot gas and material temperatures. Alternatively, if part of the cooling air which is economised is used for reducing the maximum flame temperature, pollutant emissions can be reduced.

Despite a finer spatial resolution than any of the adjustable prior art solutions the method of construction of the inventive combustor casing is simple and efficient, so the variable cooling can be made economically.

Another advantage of the inventive combustor casing, where a problem hot spot automatically activates the appropriate bimetallic element, is the threefold increased reliability. Firstly, reducing (or even eliminating) thermal stresses between hotter and cooler areas of the same part can significantly increase part life. Secondly, avoiding contact surfaces between parts in relative motion improves reliability compared to active cooling adjustment systems. Thirdly, there is no need for a (failure-prone) sensor and control system to decide which actuator to operate and by how much.

### BRIEF DESCRIPTION OF THE DRAWINGS

The invention will now be further described, with reference to the accompanying drawings in which:

FIG. 1 schematically shows a longitudinal section through a combustor.

FIG. 2 schematically shows part of a combustion chamber with inner and outer casing;

FIG. 3 is a sectional view of inner and outer casing of a combustor with bimetallic elements arranged on the inner side of the inner casing;

FIG. 4 is a sectional view of the inner and outer casings with bent bimetallic elements arranged on the inner side of the inner casing but reacting to a hot spot;

FIG. 5 is a sectional view of the inner casing of a combustor casing with a lip formed as a bimetallic part;

FIG. 6 shows the same arrangement as FIG. 5 but reacting to a hot spot;

FIG. 7 is a sectional view of the inner casing of a combustor casing with a lip formed as a bimetallic part and a recess arranged upstream the lip; and

FIG. 8 shows the same arrangement as FIG. 7 but reacting to a hot spot.

In the drawings like references identify like or equivalent parts.

### DETAILED DESCRIPTION OF THE INVENTION

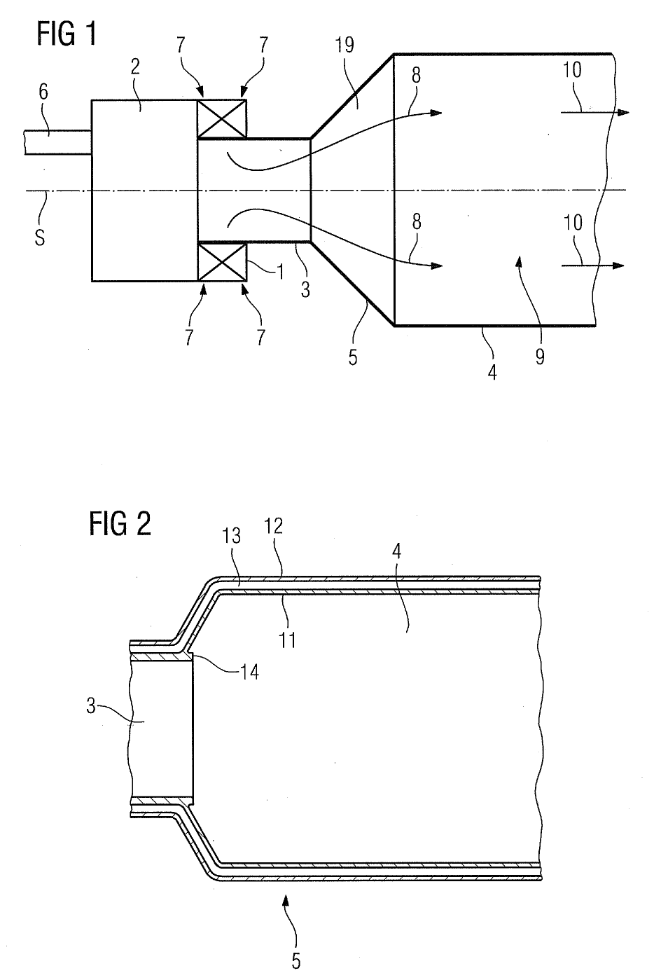

Referring to the drawings, FIG. 1 schematically shows a longitudinal section through a combustor. The combustor comprises a burner with a swirler portion 1 and a burner-head portion 2 attached to the swirler portion 1, a transition piece being referred to as a combustion pre-chamber 3 and a main combustion chamber 4 arranged in flow series with a dome portion 19 between the pre-chamber 3 and the main combustion chamber 4. The main combustion chamber 4 has a larger diameter than the diameter of the pre-chamber 3. The main combustion chamber 4 and the pre-chamber 3 are formed by the combustor casing 5.

In general, the pre-chamber 3 may be implemented as a one part continuation of the burner-head 2 towards the combustion chamber 4, as a one part continuation of the combustion chamber 4 towards the burner-head 2 or as a separate part between the burner-head 2 and the combustion chamber 4. The burner and the combustion chamber 4 assembly show rotational symmetry about a longitudinal symmetry axis S.

A fuel duct 6 is provided for leading a gaseous or liquid fuel to the burner which is to be mixed with in-streaming air 7 in the swirler 1. The fuel-air-mixture 8 is then led towards the primary combustion zone 9 where it is burnt to form hot, pressurised exhaust gases flowing in a direction 10 indicated by arrows to a turbine of the gas turbine engine (not shown).

FIG. 2 schematically shows part of a combustor casing 5, comprising a main combustion chamber 4 and a pre-chamber 3 in a sectional view. The main combustion chamber 4 and, in particular, the pre-chamber 3, comprises an inner casing 11 and an outer casing 12. There is an internal space 13 between the inner casing 11 and the outer casing 12 which may be used as cooling air channel for cooling the inner casing 11. The inner casing 11 comprises a lip 14.

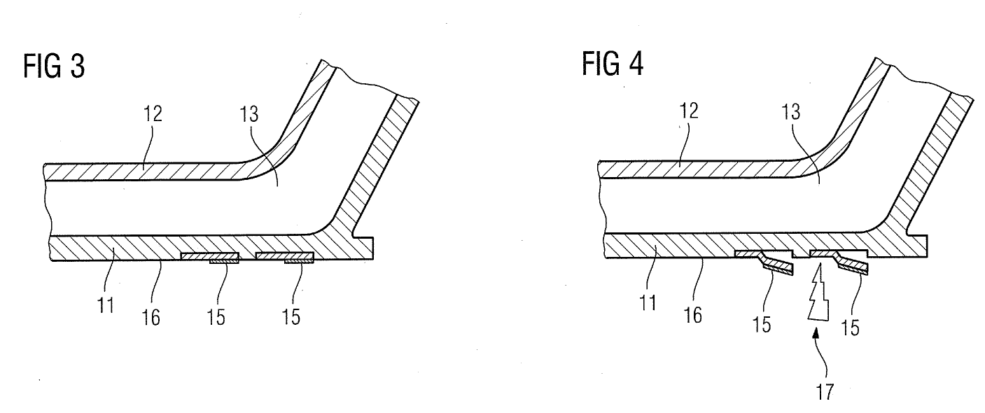

FIGS. 3 and 4 show sectional views of part of a combustor casing with bimetallic elements 15 arranged on the inner side 16 of the inner casing 11. In FIG. 3, no hot spot is present and the bimetallic elements 15 rest against the wall of the inner casing 11. They could of course also be in another position. The main thing is that the bimetallic element has the possibility to bend.

On the occurrence of hot spots 17 as shown in FIG. 4, or simply, when the temperature changes, the bimetallic elements 15 bend and crack away any carbon build-up responsible for such hot spots, the burning of which carbon could distort or even erode parts of the burner duct.

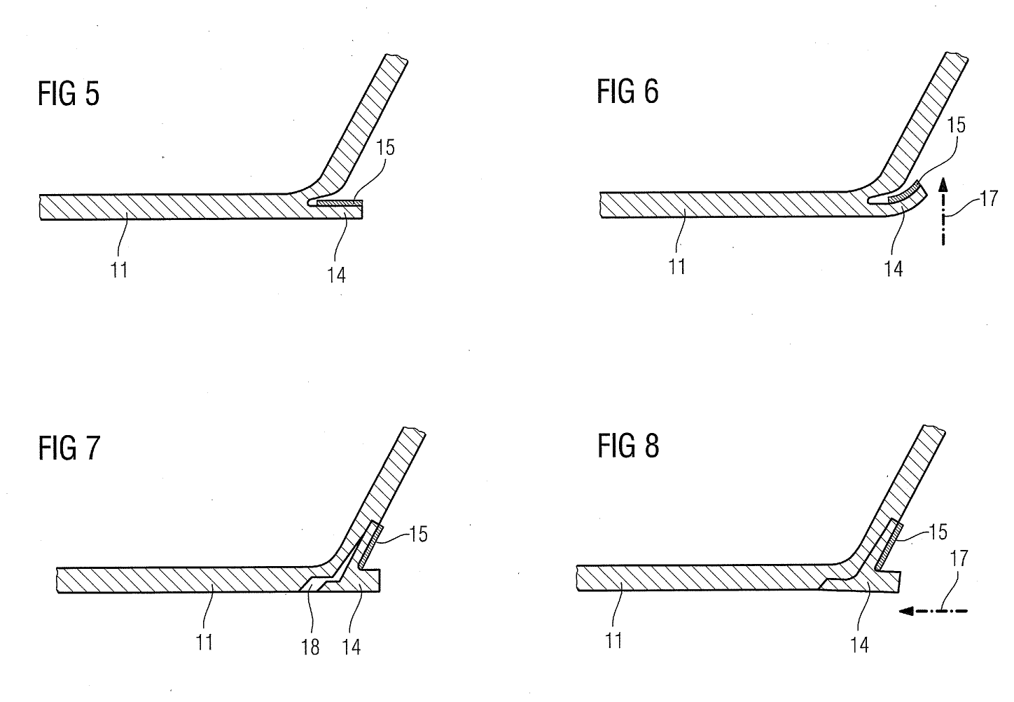

FIG. 5 shows a sectional view of the inner casing 11 of a combustor casing 5 with a lip 14 formed as a bimetallic part with bimetallic element 15. In the presence of an overheating source 17 the lip 14 moves away from the heat source, as shown in FIG. 6.

A similar arrangement is shown in FIGS. 7 (without hot spot) and 8 (with hot spot). Again, the lip 14 is formed as a bimetallic part 15. But in this arrangement the bimetallic element 15 is arranged on the lip 14 such that the lip 14 can move in an upstream direction, where a recess 18 is arranged, to reduce the total pre-chamber length.

Both movements shown in FIGS. 5 and 6, as well as in 7 and 8, do not only shift the heated part away from the heating source, they also detach deposited carbon.

It is common to the embodiments of FIGS. 3 to 8 that not the whole inner casing 11 is bent but only a fraction of the casing or a sheet that is connected to the casing. The inner casing 11 remains unbent, even in case of a hot spot 17. Local hot spots 17 at the inner casing 11 may arise due to a cover of deposits at the radially inner surface of the inner casing 11, so that the cooling effect of the inner casing 11 surface will decrease. Without providing additional cooling air, the invention allows bending the sheet with bimetallic elements 15 radially inwards so that the deposit is cracked away, which removes the local hot spot 17. Without having the local hot spot 17, the sheet with bimetallic elements 15 may bend back again to its starting position. It has to be denoted that a material may be advantageous so that a sufficient bending radius for cracking of the deposits may be reached.

Alternatively the local hot spots 17 may occur at a lip 14 due to the position of the flame in the combustor. Bending of the lip 14 radially outwards or radially inwards allows adjusting the flame position within the combustor. By adjusting the flame position away from local hot spots 17—possibly further downstream—, local hot spots 17 may be reduced without providing additional cooling air.

Thus it is common to the different embodiments to reduce local hot spots 17 without providing additional cooling air or without manipulating cooling air holes or cooling passages. Merely the inner surface of the inner casing is altered.

1.-8. (canceled)

9. A combustor casing, comprising:
an inner casing with a pre-chamber area;
an outer casing; and
a bimetallic element arranged on an inner side of the inner casing,
wherein a combustion is initiated in the pre-chamber area in a fuel rich state, the pre-chamber area including an upper end and a lower end, the upper end being sized and configured to be connected to a burner head, and
wherein the bimetallic element is located within the pre-chamber area.

10. The combustor casing as claimed in claim 9, wherein the bimetallic element is sized and configured to crack away deposits.

11. The combustor casing as claimed in claim 10, wherein the deposits are carbon build-ups.

12. The combustor casing as claimed in claim 9, wherein the bimetallic element is arranged to bend inwardly relative to a longitudinal axis of the inner casing in a reaction to an occurrence of a hot spot.

13. The combustor casing as claimed in claim 9, wherein the bimetallic element is a lip arranged at the lower end of the pre-chamber area for flame anchoring.

14. The combustor casing as claimed in claim 13, wherein the lip is arranged to bend outwardly relative to a longitudinal axis of the inner casing in reaction to an occurrence of a hot spot.

15. The combustor casing as claimed in claim 13, wherein a recess is arranged in a wall of the inner casing and located in a wall area of the pre-chamber area, the recess being sized and configured to allow the lip to bend in a direction of the upper end in reaction to the occurrence of a hot spot.

16. A gas turbine, comprising:
a combustor casing, the combustor casing comprising:
an inner casing with a pre-chamber area;
an outer casing; and
a bimetallic element arranged on an inner side of the inner casing,
wherein a combustion is initiated in the pre-chamber area in a fuel rich state, the pre-chamber area including an upper end and a lower end, the upper end being sized and configured to be connected to a burner head, and
wherein the bimetallic element is located within the pre-chamber area.

17. The gas turbine as claimed in claim 16, wherein the bimetallic element is sized and configured to crack away deposits.

18. The gas turbine as claimed in claim 17, wherein the deposits are carbon build-ups.

19. The gas turbine as claimed in claim 10, wherein the bimetallic element is arranged to bend inwardly relative to a longitudinal axis of the inner casing in a reaction to an occurrence of a hot spot.

20. The gas turbine as claimed in claim 10, wherein the bimetallic element is a lip arranged at the lower end of the pre-chamber area for flame anchoring.

21. The gas turbine as claimed in claim 20, wherein the lip is arranged to bend outwardly relative to a longitudinal axis of the inner casing in reaction to an occurrence of a hot spot.

22. The gas turbine as claimed in claim 20, wherein a recess is arranged in a wall of the inner casing and located in a wall area of the pre-chamber area, the recess being sized and configured to allow the lip to bend in a direction of the upper end in reaction to the occurrence of a hot spot.
